(19) United States
(12) Patent Application Publication
(10) Pub. No.: US 2002/0168976 A1
(43) Pub. Date: Nov. 14, 2002

(54) Accelerating acquisition of a preferred cellular system by a portable communication device using position location

(76) Inventor: Ram Krishnan, San Diego, CA (US)

Correspondence Address: Qualcomm Incorporated, Patents Department, 5775 Morehouse Drive, San Diego, CA, 92121-1714, US

(21) Appl. No.: 09/912,794

(22) Filed: Jul. 24, 2001

Related U.S. Application Data
(60) Provisional application No. 60/276,378, filed on Mar. 16, 2001.

(51) Int. Cl. H04Q 7/20

(52) U.S. Cl. 455/432; 455/433

(57) ABSTRACT

A mobile communication device, and a method of connecting a mobile device to a preferred communication system, are disclosed. The mobile communication device includes a signal sender, a signal receiver, and a processor and memory. The processor and memory include a static table, and are in communication with the signal sender and the signal receiver. The processor and memory match a location of the device directly to at least one preferred system. The mobile communication system includes at least one base station and the at least one mobile communication device. The method includes the step of locating of the mobile communication device, the step of converting the location generated into a position range, the step of matching the position range to at least one preferred SID index for the position range using a lookup table, the step of selecting the preferred SID from a roaming list, wherein the preferred SID is correspondent to the at least one preferred SID index, and the step of connecting the mobile communication device to a channel correspondent to the preferred system indicated by the preferred SID.

### RELATED APPLICATIONS

This application claims priority to U.S. Provisional Application No. 60/276,378, filed Mar. 16, 2001.

### BACKGROUND OF THE INVENTION

1. Field of the Invention

The present invention is directed generally to a method and apparatus for the acquisition of a cellular system and, more particularly, to using position location to accelerate the acquisition of a preferred cellular system by a portable communication device.

2. Description of the Background

When mobile station equipment or mobile communication devices, such as portable telephones, are powered on, i.e. are activated, the mobile communication devices search for signals from base stations. The mobile communication device must register with a suitable base station in order to provide service to the user. At a given time, an activated portable communication device 10 may find signals from several different base stations 20, 30, 40, 50, some of which are home 20 and some of which are roam 30, 40, 50, and some of which are preferred 20, 40 and some of which are not 30, 50, as shown in FIG. 1. For example, in the case of IS-95 CDMA systems, the mobile communication device uses an IS-683-A roaming list to search for base stations.

The activated mobile communication device may receive signals from base stations that are part of the home system for that device, part of a competitor's system, or part of a competitor's system that has a usage agreement with the home system, for example. The base station that is part of the home system is the most preferred system for the activated mobile communication device to send and receive signals to and from, because the user is typically already paying for the use of that home system. A less preferred system may be a base station that is part of a competitor's system that has a usage or roam agreement with the home system. According to the terms of the roam agreement, the user may incur additional, but discounted, fees for usage, when using the competitor's system with a usage or roam agreement. The least preferred system may be, for example, a base station that is part of a competitor's system that does not have a usage or roam agreement with the home system. Thus, the user, or the home system, may incur substantial additional fees for usage of the base station that is part of the competitor's system, which will frequently require roaming to use the competitor's system without an agreement to the contrary.

Thus, an activated mobile communication device uses one of several methods to identify the most preferred system for the user. In the case of IS-95 CDMA based systems, for example, the phone will use the IS-683-A standard roaming list that lists the systems that can be used arranged by preference and geographic regions. A typical layout of such a roaming list information is shown below in Table 1.

TABLE I
Typical Roaming List

| | | | Block or | | | | |
|---|---|---|---|---|---|---|---|
| | | | Channel | Roam | Geographic | Desirability | |
| | SID | NID | Number | Indicator | Region | factor | Preference |
| First | 101 | 1 | 425 | Off | New | No | Preferred |
| Geographic | 102 | 2 | 500 | Off | Same | Yes | Preferred |
| Region | 103 | 300 | 758 | On | Same | No | Preferred |
| | . . . | | | | | | |
| | . . . | | | | | | |
| | . . . | | | | | | |
| | 250 | * | 600 | On | Same | No | Preferred |
| | 260 | 6 | 620 | On | Same | No | Negative |
| Second | 201 | 10 | 425 | | New | No | Preferred |
| Geographic | 202 | 11 | A | | Same | No | Preferred |
| Region | . . . | | | | | | |
| | . . . | | | | | | |
| Third | 300 | 65 | 283 | On | Same | No | Preferred |
| Geographic | 301 | * | B | Off | New | No | Preferred |
| Region | . . . | | | | | | |
| | . . . | | | | | | |

The locations of activated portable communication devices are specific geographic regions, according to protocols such as IS-683-A. These specific geographic regions group together various mobile communication systems in the same geographic region. Thus, systems in the same geographic region are differentiated from other cellular systems in another geographic region. For example, the first system in a geographic region is identified as the first new geographic region, and subsequent systems in the same geographic region are identified as being in the same geographic region but and as being in the first new geographic region. If the subsequent cellular system is in a different geographic region, the system is identified as in the second new geographic region.

Within a specific geographic region, the system identifier (SID), and the network identifier (NID), identify the system. For example, the system and network may be ‘Airtouch®’, or ‘Sprint®.’ The roaming indicator then indicates if the system, such as ‘Sprint’, is a home system or a roam system. For example, if the home system is ‘Sprint’, then any system that is ‘Sprint’ will be identified as the home system with roam indicator reading “Off,” but non-Sprint systems will be identified as a roam system with the roam indicator reading “On.”

The block or channel number in Table I indicates the frequency of transmission of a base station. The Preference column of Table I indicates whether a system is preferred or negative. Preferred systems will be acquired, but negative systems will not be acquired except in the case of emergency calls. Desirability indicates whether a first cellular system is more desirable than a subsequent cellular system. For example, in the first geographic region, the first system (SID 101, NID 1) is not more desirable than the second system (SID 102, NID 2). However, the second system (SID 102, NID 2) is more desirable than the third system (SID 103, NID 300).

Mobile communication devices typically have large roaming areas that span several geographic regions, due to the prevalence of communication networks world-wide and the service provider's desire to provide preferred service for the users wherever they travel. Each geographic region may have several SIDs in it. Mobile communication devices preferably have the capability to remember the last geographic region, or SID, that the particular device was connected to the last time the particular device was powered off, and the capability to quickly and efficiently search that appropriate region when the device is powered on the next time. However, if the user is traveling, and the device is powered on in a new geographic region not overlapping the prior appropriate region, the device will then have to search sequentially for every entry in each geographic region in order to find the preferred service. This search process is inconvenient for the user in that it can take a long time, sometimes as long as several minutes.

Algorithms available currently take an “educated guess” at the correct geographic region by looking at an acquired SID, but such algorithms work properly only if the mobile communication devices acquires a known system (i.e. a system with the SID in the roaming list). If the phone does not acquire a known system, an “educated guess” system may take an exceedingly long time to find the most preferred system, particularly if the geographic regions are large.

Therefore, the need exists for a mobile communication device and system that allows a system to be quickly acquired, based on the location of a user, without the need to search all available geographic locations and systems until a preferred system is located.

### BRIEF SUMMARY OF THE INVENTION

The present invention is directed to a mobile communication device. The mobile communication device includes a signal sender, a signal receiver, and a processor and memory. The processor and memory include a static table, and are in communication with the signal sender and the signal receiver. The processor and memory match a location of the device directly to at least one preferred system. The mobile communication device may additionally include a location converter to convert a location from a locator into a position range for comparison in the static table. The position locator is a receiver contained in the mobile communication device. The static table preferably includes at least one roaming list and at least one lookup table.

The present invention is also directed to a mobile communication system. The mobile communication system includes at least one base station and at least one mobile communication device. The mobile communication device includes a signal sender, a signal receiver, and a processor. In a preferred embodiment, each mobile station includes a position locator, and the locator locates the mobile communication device and sends that geographic location to the location converter. The location converter converts the location generated by the locator into a geographic region in a static table.

Additionally, the present invention is directed to a method of connecting a mobile device to a preferred communication system. The method includes the step of locating the position of the mobile communications device, via a locator function, the step of converting the location generated into a position range, the step of matching the position range to at least one preferred SID index for the position range using a lookup table, the step of selecting the preferred SID from a roaming list, wherein the preferred SID is correspondent to the at least one preferred SID index, and the step of connecting the mobile device to a channel correspondent to the preferred SID. In an embodiment wherein at least two preferred SID indexes match the position range, the method further includes sequentially searching, according to an order of preference, at least two channels correspondent to the at least two preferred SID indexes before the step of selecting.

The present invention is further directed to a mobile communication device having a processor therein, which processor may include a memory, and which processor is communicatively connected to the device, and which processor includes thereon computer software that performs the step of converting a location of the mobile device to a position range, the step of matching the position range to at least one preferred SID index for the position range using a lookup table, wherein the lookup table is stored in the memory, the step of selecting the preferred SID from a roaming list, wherein the preferred SID is correspondent to the at least one preferred SID index, wherein the roaming list is stored in the memory, and the step of connecting the mobile device to a channel correspondent to the preferred SID.

The present invention solves problems experienced with the prior art because it provides a portable communication device and system that allows a system to be quickly acquired, based on the location of a user, without the need to search all available geographic locations and systems until a preferred system is located. Those and other advantages and benefits of the present invention will become apparent from the detailed description of the invention hereinbelow.

### BRIEF DESCRIPTION OF THE SEVERAL VIEWS OF THE DRAWING

For the present invention to be clearly understood and readily practiced, the present invention will be described in conjunction with the following figures, wherein:

FIG. 1 is a schematic diagram illustrating a mobile communication system;

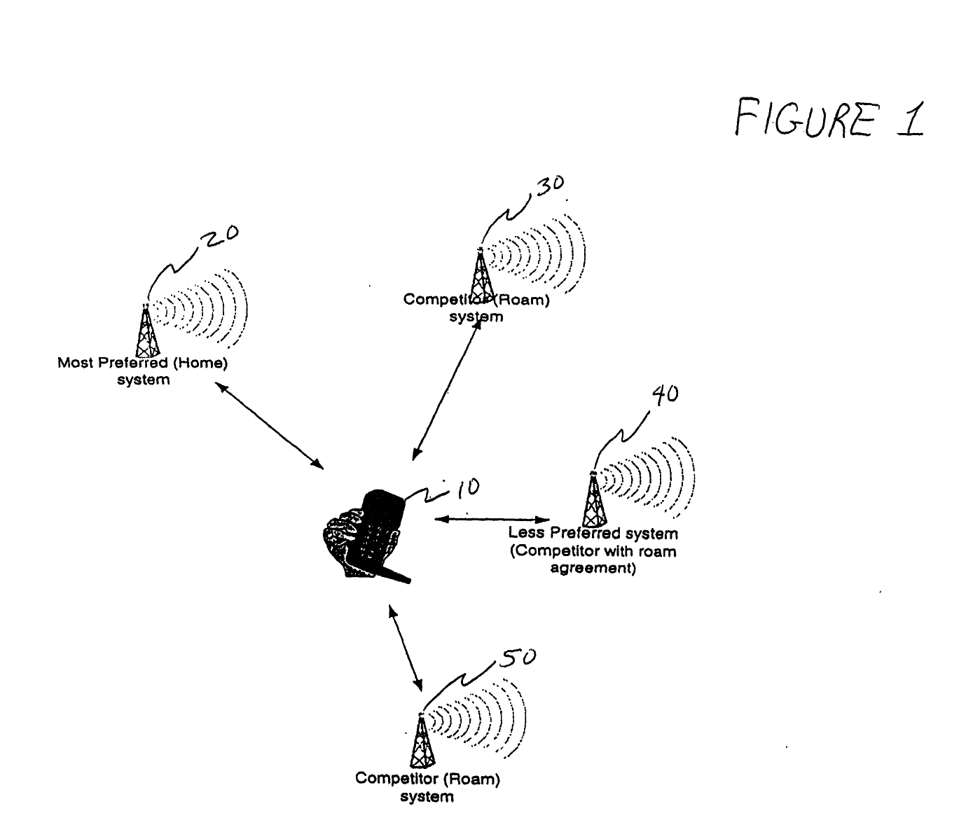

FIG. 2 is a block diagram illustrating a mobile communication device;

FIG. 3 is a graphic illustration illustrating a static table for use in the mobile communication device; and

FIG. 4 is a flow diagram illustrating a method of connecting a mobile device to a preferred communication system.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical communication device and system. Those of ordinary skill in the art will recognize that other elements are desirable and/or required in order to implement the present invention. However, because such elements are well known in the art, and because they do not facilitate a better understanding of the present invention, a discussion of such elements is not provided herein.

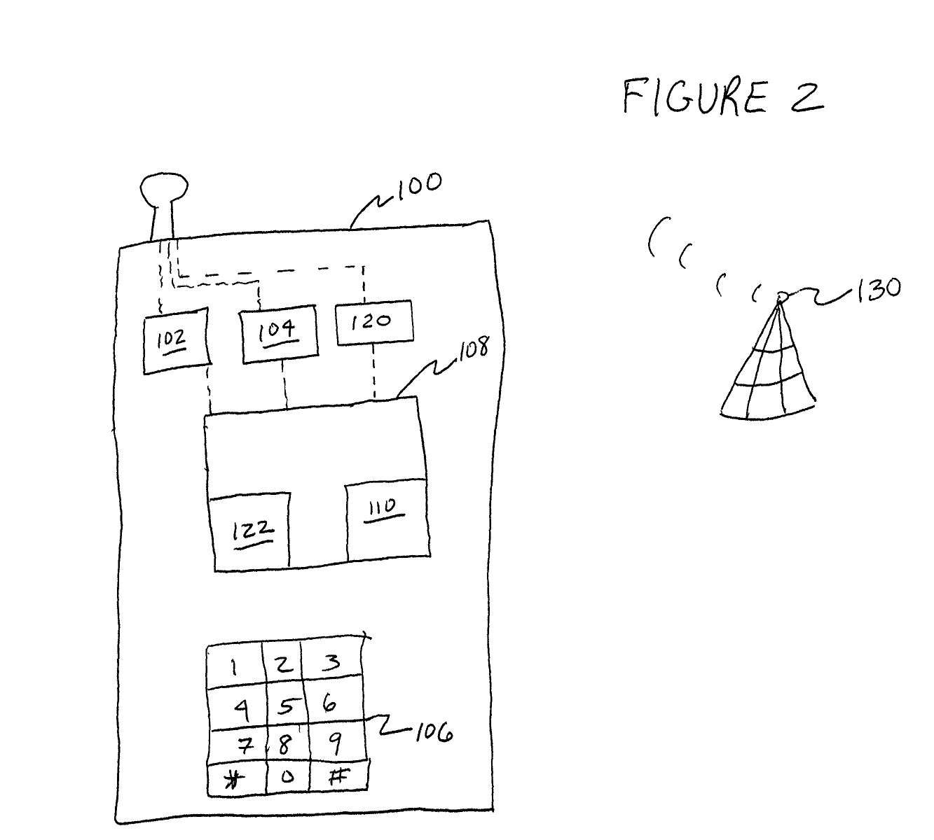

FIG. 2 is a block diagram illustrating a mobile communication device 100. The device 100 may include a signal sender 102, a signal receiver 104, an information entry portal 106, a processor and/or memory 108, including a static table 110, and, in a preferred embodiment, a locator 120 and location converter 122.

The signal sender 102 and receiver 104 are known to those skilled in the art, and may be, for example, a receiver or transceiver in a device such as a portable telephone. The information entry portal 106 may be, for example, a keypad, touch screen, or other information entry portal known to those skilled in the art.

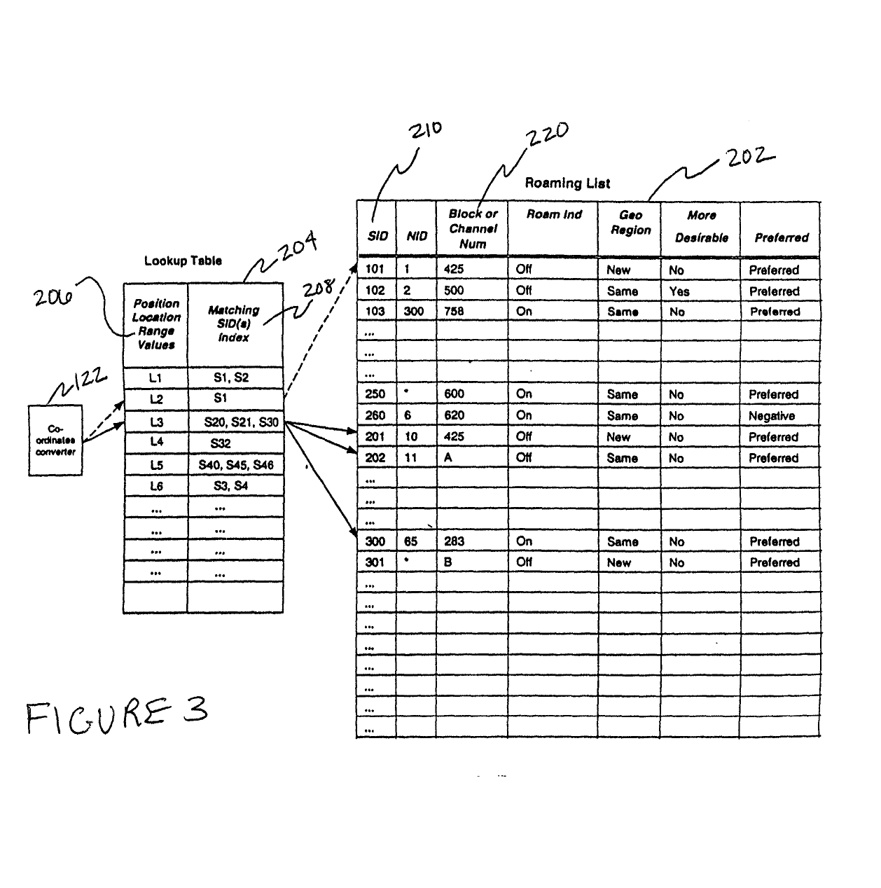

The memory 108 may be any form of digital storage device, for example, discrete or embedded RAM, re-writable PROM such as EEPROM, or storage cells in an ASIC or FPGA configured as either registers or RAM or any other type of simple or complex memory device known to those skilled in the art. The memory 108 may be connected to or may be included in a processor. The memory 108 includes thereon a static table 110. A preferred embodiment of a static lookup table 110 is shown in FIG. 3. A static table 110 for use in the present invention preferably includes a form of at least one roaming list 202, such as that shown in Table 1. However, rather than dividing the roaming list 202 by geographic region, as in Table 1, which division by geographic region requires searching anew with each change in geographic region, the roaming list 202 of FIG. 3 is keyed to a lookup table 204. The lookup table 204 matches a known geographic position 206 with an SID index 208, which SID index 208 corresponds to an SID 210 in the roaming list 202, without a need to search through each SID 210 in a roaming list 202 for a geographic location. The SIDs may be index keyed, such as SID position 1 (SID1) being keyed to location L2, which SID1 index key in FIG. 3 corresponds to SID 101 in Table 1, or directly keyed to geographic location, such as L2 being directly matched with SID 101. Thus, the roaming list 202 lists the preferential status of each system in the roaming list 202, and corresponds each system to an SID number 210. This SID number 210 corresponds to an SID index 208, which SID index 208 is listed in the lookup table 204, and is matched in that lookup table 204 to a position range 206. The static table 110 is preferably present on the mobile communication device 100. The static table 110 may be updated on each power up of the device 100, or may be updated at predetermined intervals, such as weekly, for example. The update may occur at the base station, and may be transferred to the device 100 upon contact with the base station on power up, for example, in an embodiment wherein the static table is maintained on the device 100.

In operation, when a position 206 is received in the lookup table 204, the preferred SIDs 208 are immediately known, and the communication device 100 can be immediately tuned to the correct channel 220 to allow the acquisition of the system 20, 30, 40, 50 with the preferred characteristics. For example, in the above example, when the received location is L2, S1 is recognized as the matching SID index, and corresponds to SID 101, which occupies channel 425. Thus, the communication device 100 is then tuned to channel 425 and SID 101 is acquired. Certain locations will have multiple SIDs that are preferred in a certain order. For example, a first system might be the first provider network, the second a low-rate second provider having an agreement with a first provider, and the third a third provider having a standard rate agreement with the first provider. Thus, the first network is most preferred, the second is the second most preferred, and the third is preferred, but the least preferred. In such an instance, such as when the location 206 is L3 in FIG. 3, the location 206 may match multiple indices 208, such as S20, S21, and S30 in FIG. 3, and the channels 220 correspondent to those SID indices are then tuned into, in a sequence correspondent to the order of preference of the networks correspondent to the SIDs correspondent to those channels 220, until a preferred system 20 connection is made.

The location 206 on which the lookup table 204 is keyed in FIG. 3 is preferably generated by a locator 120, which is preferably present in the mobile communication device 100. The locator 120 may be satellite based, such as by the use of the Global Positioning System, (GPS), wherein satellite tracking is used to locate the mobile communication device 100, or triangulation based, wherein multiple base stations 130 having locator beacons or other appropriate signals therein, enable the mobile communication device locator 120 to measure the distance between the mobile device 100 and the fixed position base station beacons, and, through a difference algorithm, generate a location 206.

In general, a locator 120 generates location in the form of “xyz” coordinates, which “xyz” coordinates generally correspond to a latitude location (“x”, a longitude location (“y”), and a height location (“z”). Thus, for example, a location 206 for a mobile device 100 might be generated, using triangulation, as 60°, 20′05″, 35° 01′29″, 82. In a preferred embodiment, this “xyz” location is then converted by the location converter 122 to the geographic regions specified by the carriers in one or more roaming lists 202. For example, the above coordinates might fall in geographic region 1 in Table I hereinabove, which coordinates are correspondant to L1 according to the location converter 122 in FIG. 3, and thus L1 corresponds to geographic region 1. The location converter 122 is preferably software, and may be present in the processor and/or memory 108 at the mobile communication device 100.

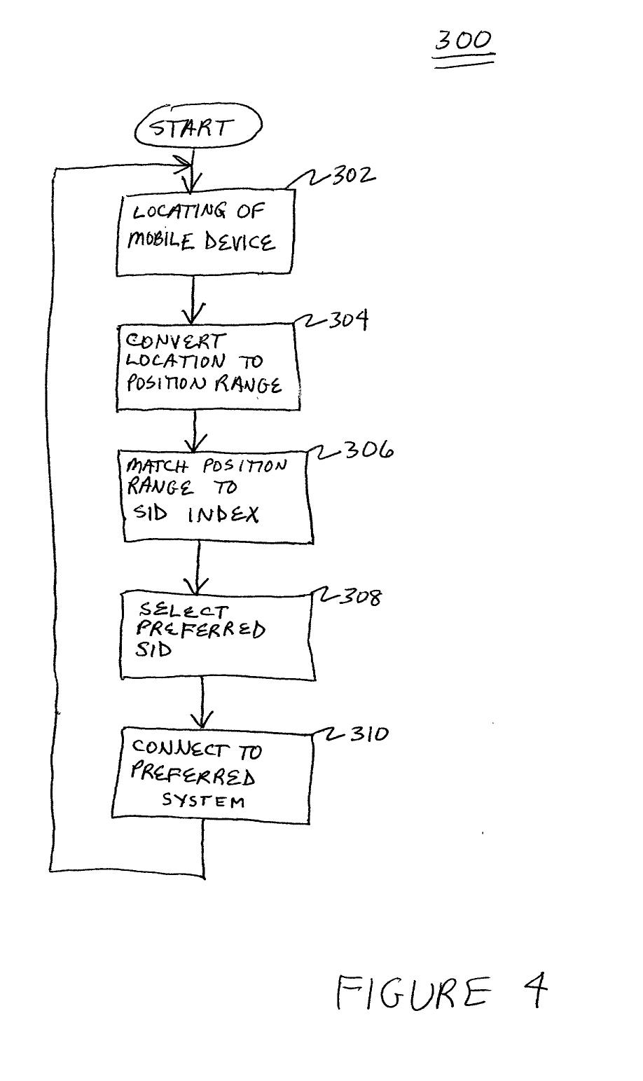

FIG. 4 is a flow diagram illustrating a method 300 of connecting a mobile device to a preferred communication system. The method 300 preferably includes the step 302 of locating, using the locator function of the mobile communication device, the step 304 of converting the location generated to a position range, the step 306 of matching the position range to at least one preferred SID index for the position range using a lookup table, the step 308 of selecting the preferred SID from a roaming list, wherein the preferred SID is correspondent to the at least one preferred SID index, and the step 310 of connecting the mobile communication device to a channel correspondent to the preferred SID. It will be apparent to those skilled in the art that the method of FIG. 4, as well as the corresponding elements of FIGS. 2 and 3, may be performed each time the device is powered on, periodically at predetermined intervals, or each time it becomes necessary to engage a new system or new base station.

Those of ordinary skill in the art will recognize that many modifications and variations of the present invention may be implemented. The foregoing description and the following claims are intended to cover all such modifications and variations.

What is claimed is:

1. A mobile communication device, comprising:
a signal sender;
a signal receiver; and
a memory, including a static table, in communication with said signal sender and said signal receiver, wherein said memory matches a location directly to at least one preferred system according to the static table.

2. The mobile communication device of claim 1, further comprising a location converter.

3. The mobile communication device of claim 1, wherein said signal sender and said signal receiver comprise a mobile telephone sender and a mobile telephone receiver.

4. The mobile communication device of claim 1, wherein said memory comprises at least one digital storage device.

5. The mobile communication device of claim 1, further comprising a processor in communication with said signal sender, said signal receiver, and said memory.

6. The mobile communication device of claim 1, wherein the static table comprises at least one roaming list and at least one lookup table.

7. The mobile communication device of claim 6, wherein, upon accessing of a base station by said signal sender, the at least one lookup table matches a known geographic position of the device with respect to the base station with an SID index in the roaming table.

8. The mobile communication device of claim 7, wherein, upon matching of the geographic position with an SID index, the mobile communication device tunes to a preferred channel of the matched SID index.

9. The mobile communication device of claim 8, wherein the device tunes to a preferred channel by a searching of at least two preferred channel sequenced by a preference until a preferred channel is connected to by the mobile communication device.

10. The mobile communication device of claim 1, further comprising a locator.

11. The mobile communication device of claim 10, wherein said locator utilizes GPS.. to locate the mobile communication device

12. The mobile communication device of claim 10, wherein said locator utilizes triangulation to locate the mobile communication device.

13. The mobile communication device of claim 10, further comprising a location converter, wherein said location converter converts a location generated by said locator into a geographic region in the static table.

14. The mobile communication device of claim 13, wherein said location converter comprises a software program resident in said memory.

15. A mobile communication system, comprising:
at least one base station; and
at least one mobile communication device, comprising:
a signal sender that send signals to said at least one base station;
a signal receiver that receives signals from said at least one base
station; and
a memory, including a static table, wherein said memory matches a
location of said at least one mobile communication device directly to at least
one preferred system.

16. The mobile communication system of claim 15, wherein said mobile communication device further comprises a location converter.

17. The mobile communication system of claim 15, wherein said mobile communication device further comprises a processor.

18. The mobile communication system of claim 15, wherein said static table comprises at least one roaming list and at least one lookup table.

19. The mobile communication system of claim 18, wherein, upon accessing of at least one of said at least one base station by said mobile communication device, the at least one lookup table matches a known geographic position of said mobile communication device with respect to at least one of said at least one base station with an SID index in the roaming list.

20. The mobile communication system of claim 15, further comprising at least one locator.

21. The mobile communication system of claim 20, wherein said locator utilizes GPS to locate said mobile communication device.

22. The mobile communication system of claim 15, comprising at least three base stations, wherein said locator utilizes triangulation to locate said mobile communication device.

23. The mobile communication system of claim 20, wherein said device further comprises said locator, and wherein said locator locates said mobile communication device.

24. The mobile communication system of claim 23, wherein said locator utilizes GPS.to locate said mobile communication device.

25. The mobile communication system of claim 20, further comprising a location converter, wherein said location converter converts a location generated said mobile communication device by said locator into a geographic region in the static table.

26. A method of connecting a mobile communication device to a preferred communication system, comprising:
locating the mobile communication device using a location function within the mobile communication device;
converting the location generated by said locating to a position range;
matching the position range to at least one preferred SID index for the position range using a lookup table;
selecting a preferred SID system from a roaming list, wherein the preferred SID system is correspondent to the at least one preferred SD index; and
connecting the mobile communication device to a channel correspondent to the preferred SID system identified by the at least one preferred SID index.

27. The method of claim 26, wherein at least two preferred SID indexes match the position range, further comprising sequentially searching, according to an order of preference, at least two channels correspondent to the at least two preferred SID indexes before said selecting.

28. A mobile communication device, comprising:
a signal sender;
a signal receiver; and
a processor, including a memory, communicatively connected to said signal sender and said signal receiver, which processor includes thereon computer software that performs the steps of:
converting a location of the mobile communication device to a position range;
matching the position range to at least one preferred SID index for the position range using a lookup table, wherein the lookup table is stored in the memory;
selecting a preferred SID from a roaming list, wherein the preferred SID is correspondent to the at least one preferred SID index, wherein the roaming list is stored in the memory; and
connecting the mobile device to a channel correspondent to a preferred system indicated by the preferred SID.

29. The mobile communication device of claim 28, wherein the lookup table comprises a plurality of position ranges, and a plurality of SID indexes, and wherein at least one SID index is matched to each position range.

30. The mobile communication device of claim 29, wherein the roaming list comprises a plurality of available systems listed according to at least one system characteristic of each system, which system characteristic includes at least a preferential status of each system, wherein each system is keyed to a SID.

31. A system for connecting a mobile communication device to a preferred communication system, comprising:
means for locating the mobile communication device;
means for converting the location generated by said locating to a position range;
means for matching the position range to at least one preferred SID index for the position range;
means for selecting the preferred SID, wherein the preferred SID is correspondent to the at least one preferred SID index; and
means for connecting the mobile communication device to a channel correspondent to a preferred system indicated by the preferred SID.
